(19) United States
(12) Patent Application Publication
(10) Pub. No.: US 2009/0116416 A1
(43) Pub. Date: May 7, 2009

(54) WIRELESS COMMUNICATION APPARATUS

(76) Inventor: Masahiro SEKIYA, Inagi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/258,821

(22) Filed: Oct. 27, 2008

(30) Foreign Application Priority Data
Nov. 1, 2007 (JP) 2007-285138

(51) Int. Cl. H04B 7/00

(52) U.S. Cl. 370/310

(57) ABSTRACT

A wireless communication apparatus includes a received frame analysis unit, a received frame bitmap information storage unit, a bitmap reset determination unit, a Block Ack frame generation unit, and a TID bitmap storage unit. The received frame analysis unit analyzes a received MAC frame. The received frame bitmap information storage unit stores delivery acknowledgement of the received MAC frame. The bitmap reset determination unit determines whether or not information stored in the received frame bitmap information storage unit should be reset or not. The Block Ack frame generation unit generates a Block Ack frame including a bitmap to be stored in the received frame bitmap information storage unit on the basis of the delivery acknowledgement request analyzed by the received frame analysis unit. The TID bitmap storage unit stores an identifier of a frame allowing the received frame bitmap information storage unit to store the delivery acknowledgement.

### CROSS-REFERENCE TO RELATED APPLICATIONS

This application is based upon and claims the benefit of priority from prior Japanese Patent Application No. 2007-285138, filed Nov. 1, 2007, the entire contents of which are incorporated herein by reference.

### BACKGROUND OF THE INVENTION

1. Field of the Invention

The present invention relates to a wireless communication apparatus for use in a wireless communication system adopting a Block Ack mechanism which collectively transmits delivery acknowledgement as one frame to reception of a plurality of frames.

2. Description of the Related Art

As regards a wireless communication system in which a plurality of wireless communication apparatus share the same medium to communicate, Institute of Electrical and Electronics Engineers (IEEE) 802.11 standards have been known. A wireless LAN system based on these IEEE 802.11 standards use a carrier frequency of the 2.4-GHz band, and maximum data transmission speed is 2 Mbps. In this wireless LAN system, up to now, high-speed operation data transmission has been achieved by mainly changing a protocol in a physical layer. At present, wireless LAN standards of IEEE 802.11g (established in 2003) in the 2.4-GHz band, and IEEE 802.11a (established in 1999) in the 5-GHz band exist, and both the maximum data transmission speeds are 54 Mbps.

To achieve further high-speed data transmission, a medium access control (MAC) layer and a physical layer have been considered in the IEEE 802.11n standard.

In the wireless LAN system, as regards a technique, which improves throughput in the MAC layer, a Block Ack mechanism for collectively transmitting delivery acknowledgement frames to a plurality of MAC frames as one frame, exists. A MAC layer technique which has been examined in the IEEE 802.11n standard has been referred to ‘Adrian Stephens, et al., “Joint Proposal: high throughput extension to the 802.11 Standards: MAC”, IEEE 802.11-05/1095r5 standards. January, 2006’, and a communication method using the Block Ack mechanism has been described therein.

Conventionally, in the MAC layer to be defined in IEEE 802.11 standards, the delivery acknowledgement is performed by transmitting one ACK frame for each normally received MAC frame. In the Block Ack mechanism, transmitting wireless communication apparatus continuously transmit a plurality of MAC frames, and require Block Ack frames after those continuous transmissions. Receiving wireless communication apparatus which have received the requirements immediately transmit Block Ack frames including delivery acknowledgement information to the plurality of MAC frames which have been received up to this point. This communication system shortens transmission times of ACK frames which have been individually transmitted to each MAC frame, reduces an inter-frame time intervals (inter-frame spaces [IFSs]), and improves throughput.

In a conventional wireless communication system using the Block Ack mechanism, when the receiving wireless communication apparatus stores only one bitmap information, the bitmap information is reset at every time when transmitting MAC addresses included in MAC Headers of received MAC frames or when traffic IDs of the MAC frames are varied. In such a wireless communication system, in a case in which the transmitting wireless communication apparatus continuously transmit the plurality of MAC frames, and normally receive Block Ack frames including the delivery acknowledgements to those transmissions from the receiving wireless communication apparatus, the transmitting wireless communication apparatus may acquire delivery acknowledgement information. In this case, even if the bitmap information stored in the receiving wireless communication apparatus is reset after acquisition of the above, there is no problem.

However, in a case in which the transmitting wireless communication apparatus have not received the Block Ack frames, if the bitmap information stored in the receiving wireless communication apparatus has been reset, the transmitting wireless communication apparatus may not recognize the acknowledgements of frames of which the transmission has been completed successfully. In this case, there is a need for the transmitting wireless communication apparatus to transmit the same frames again, and it makes the wireless communication system inefficient. Therefore, it is not preferable for the receiving wireless communication apparatus to reset the bitmap information without reason at every time when the transmitting MAC addresses included in the received MAC frames or the traffic IDs of the frames vary.

Up to this time, in a case in which the MAC addresses of the transmitting wireless communication apparatus included in the MAC frames are varied, the receiving wireless communication apparatus are only defined so as to reset the bitmap information, and a reset method depending on any condition other than the definition of the above is not defined.

### BRIEF SUMMARY OF THE INVENTION

According to a first aspect of the invention, there is provided a wireless communication apparatus, comprising: a received frame analysis unit which analyses a received MAC frame including MAC Header information; a received frame bitmap information storage unit which stores delivery acknowledgment information of the received MAC frame on the basis of the MAC Header information analyzed by the received frame analysis unit; and a bitmap reset determination unit which determines whether or not the delivery acknowledgement information of the received MAC frame stored in the received frame bitmap information storage unit should be reset on the basis of the MAC Header information of the received MAC frame analyzed by the received frame analysis unit, the received frame bitmap information storage unit being controlled the reset in accordance with the determination result.

According to a second aspect of the invention, there is provided a wireless communication apparatus, comprising: a received frame analysis unit which analyzes received MAC frame including MAC Header information; a plurality of received frame bitmap information storage units each stores delivery acknowledgement information of received MAC frame should be reset on the basis of MAC Header information analyzed by the received frame analysis unit; and a bitmap reset determination unit which determines whether or not the delivery acknowledgement information of the received MAC frames stored in the plurality of received frame bitmap information storage units on the basis of the MAC Header information of the received MAC frames analyzed by the received frame analysis unit, the plurality of received frame bitmap information storage units being controlled the resets in accordance with the determination result.

According to a third aspect of the invention, there is provided a wireless communication apparatus, comprising: receiving a MAC frame including MAC Header information; analyzing the MAC Header information to store delivery acknowledgement information of a received MAC frame on the basis of the analyzed MAC Header information; determining whether or not the delivery acknowledgement information of the received MAC frame stored in the storage unit should be reset on the basis of the MAC Header information of the received MAC frame; and controlling the reset of the delivery acknowledgement information stored in the storage unit on the basis of a result of the determination.

### BRIEF DESCRIPTION OF THE SEVERAL VIEWS OF THE DRAWING

FIG. 1 is a configuration view depicting an example of a wireless LAN system to which wireless communication apparatus of the present invention are applied;

FIG. 2 is a block diagram depicting a configuration of a wireless communication apparatus of a first embodiment of the present invention;

FIG. 3 is a view depicting a configuration of a representative MAC frame for use in IEEE 802.11 standards;

FIG. 4 is a view depicting a traffic ID (TID) bitmap to be stored in a TID bitmap storage unit in FIG. 2;

FIG. 5 is a view depicting an example of a frame sequence in the wireless LAN system of FIG. 1;

FIG. 6 is a flowchart depicting an example of a communication control method in the wireless LAN system of FIG. 1;

FIG. 7 is a block diagram depicting a configuration example of a PLCP service data unit (PSDU) in a case in which a plurality of MAC frames are aggregated into one frame;

FIG. 8 is a block diagram depicting configuration of a modified wireless communication apparatus of the first embodiment;

FIG. 9 is a configuration view depicting another example of the wireless LAN system to which the wireless communication apparatus of the present invention are applied;

FIG. 10 is a block diagram depicting a configuration of a wireless communication apparatus of a second embodiment of the present invention;

FIG. 11 is a view depicting an example of a frame sequence in the wireless LAN system of the FIG. 9; and

FIG. 12 is a flowchart depicting an example of a communication control method in the wireless LAN system of FIG. 9.

### DETAILED DESCRIPTION OF THE INVENTION

As described hereinbefore, it is not preferable for receiving wireless communication apparatus reset bitmap information without reason at every time when transmitting MAC addresses included in received MAC frames or traffic IDs of frames. To avoid these resets, for instance, it is limited so that the receiving wireless communication apparatus reset the bitmap information only in receiving the frames from wireless communication apparatus which communicate by using Block Ack mechanisms. Thereby, it makes possible to reduce a frequency of resets of the bitmap information without reason. In a case of the use of the Block Ack mechanisms, since negotiations are performed between transmitting wireless communication apparatus and the receiving wireless communication apparatus in advance, it is able to determine whether or not the received frames have been transmitted by using the Block Ack mechanisms.

However, to perform the aforementioned determination, the receiving wireless communication apparatus have to manage MAC addresses and traffic IDs (TIDs) of the transmitting wireless communication apparatus in performing the negotiations, and a circuit scale is increased.

In this way, resetting the bitmap information stored in the receiving wireless communication apparatus, on only the condition that the transmitting wireless communication apparatus vary, makes possibly inefficient. To determine whether or not the Block Ack mechanism is adopted in a transmission method of the received frame, the circuit scale becomes increased.

Hereinafter, description adding the aforementioned points will be described. A wireless communication system using the Block Ack mechanism has been widely known conventionally. In this wireless communication system, the transmitting wireless communication apparatus transmit together a plurality of MAC frames, to which sequence numbers are respectively assigned, to the receiving wireless communication apparatus. After this, the receiving wireless communication apparatus reply Block Ack frames including bitmap information showing delivery acknowledgement for the transmitted MAC frames to the transmitting wireless communication apparatus.

In such a wireless communication system, the receiving wireless communication apparatus store only bitmap information for one transmitting wireless communication apparatus. In a case in which the receiving wireless communication apparatus receive the MAC frames continuously transmitted from a first transmitting wireless communication apparatus, the receiving wireless communication apparatus store the delivery acknowledgement for those MAC frames as the bitmap information, and reply the Block Ack frames including the bitmap information to the first transmitting wireless communication apparatus. After this, in a case in which the receiving communication apparatus receive MAC frames from a second transmitting wireless communication apparatus, the receiving wireless communication apparatus reset the whole of the previous bitmap information, and store delivery acknowledgement for the MAC frames newly transmitted from the second transmitting wireless communication apparatus in a bitmap form.

Updating the bitmap information in this way may reduce the number of items of the bitmap information to one item and reduce the circuit scale without having to store a plurality of items of bitmap information in the receiving communication apparatus for each transmitting wireless communication apparatus.

In the aforementioned wireless communication system, the bitmap information stored in the receiving wireless communication apparatus is reset at every time when the transmitting MAC addresses of the received MAC frames have been varied. However, all the transmitting wireless communication apparatus not always transmit the MAC frames by using the Block Ack mechanism. Thus, in a case in which the MAC frames, received by the receiving wireless communication apparatus, have not been transmitted by using the Block Ack mechanism, it is not always necessary to reset the bitmap information stored in the receiving wireless communication apparatus.

It may be determined that the received MAC frames have been transmitted by using the Block Ack mechanism, for example, by confirming the kinds and types of the frames included in the MAC Headers of the received MAC frames, or the MAC addresses of the transmitting wireless communication apparatus. If the receiving wireless communication apparatus have received the frames which have transmitted from the transmitting wireless communication apparatus without using the block Ack mechanism, and if the receiving wireless communication apparatus reset the stored bitmap information, the bitmap information for the transmitting wireless communication apparatus which have been transmitting the frames by using the Block Ack mechanism results in reset to make the wireless communication apparatus inefficient.

In this way, the method for resetting the bitmap information stored in the receiving wireless communication apparatus at every time, when the transmitting MAC addresses of the received MAC frames vary, is inefficient, and it is desired to solve such a problem. Therefore, for instance, a method for preparing a list of the transmitting wireless communication apparatus which should transmit the MAC frames by using the Block Ack mechanism, and for determining whether the bitmap information should be reset in accordance with the list is a possible approach. However, it is needed for the receiving wireless communication apparatus to manage many memories in order to store the information of the MAC addresses, etc., of the transmitting communication wireless apparatus, and its results in an increase in circuit scale.

### FIRST EMBODIMENT

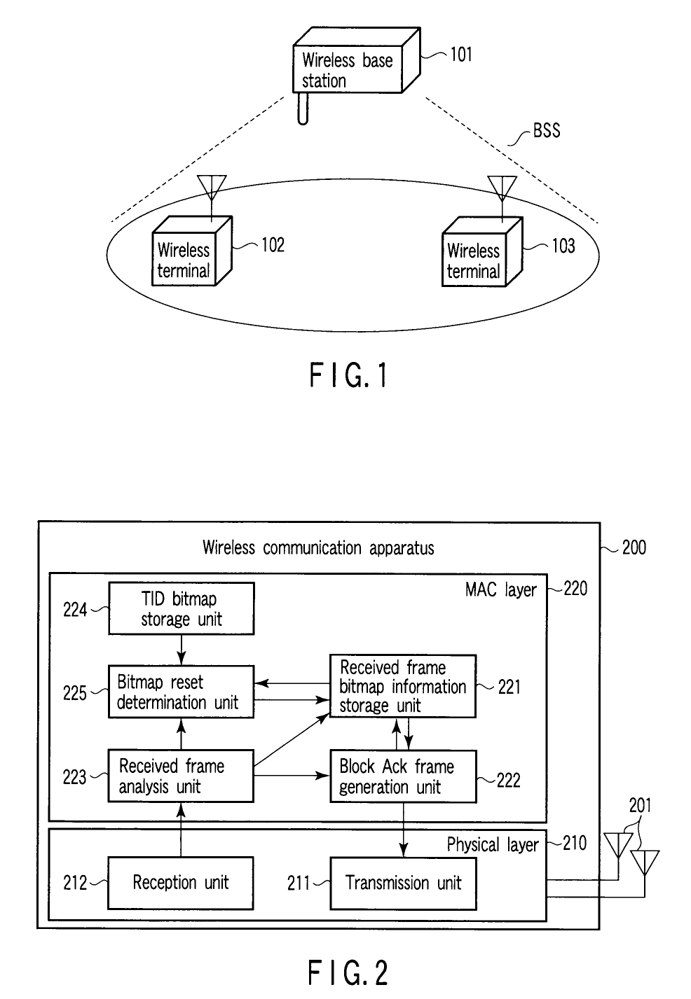

FIG. 1 is a configuration view illustrating an example of a communication form of a wireless LAN system to which wireless communication apparatus of a first embodiment of the present invention are applied. The wireless LAN system communicates depending on IEEE 802.11 standards, a plurality of wireless terminals 102-103 are wirelessly connected to one wireless base station 101. A unit composed of the base station 101 and one or more wireless terminals 102-103 is referred to as a basic service set (BSS) in IEEE 802.11 standards.

In the wireless LAN system shown in FIG. 1, a communication system, in which a first transmitting wireless communication apparatus transmits the plurality of MAC frames to receiving wireless communication apparatus, and after transmitting a frame requiring a Block Ack frame at last, the receiving wireless communication apparatus replies the Block Ack frames including bitmaps showing delivery acknowledgement information within a defined time period, is adopted.

In the wireless LAN system, when the receiving wireless communication apparatus receives the MAC frame from a second transmitting wireless communication apparatus, it is determined whether or not the stored bitmap information of the first transmitting wireless communication apparatus till then should be reset on the basis of the MAC Header information of the MAC frame received from the second transmitting wireless communication apparatus and of the bitmap of the TID to which a block Ack negotiation (ADDBA) has been established.

In the wireless LAN system of FIG. 1, the wireless base station 101, the wireless terminals 102, 103 existing in the same BSS are configured to include single antennas, respectively. However, the LAN system is not limited to the configuration shown in FIG. 1. For instance, a wireless LAN system, which is composed of a wireless base station and wireless terminals each provided with a plurality of antennas, may be used; and a BSS, in which a wireless base station with a plurality of antennas and wireless terminals with a single antenna are mixed, can be used.

FIG. 2 shows an example of a block configuration of a first example to be applied to the wireless LAN system of FIG. 1. A wireless communication apparatus 200 equivalents to the wireless base station 101 or wireless terminals 102, 103 in FIG. 1, respectively, and communicates with another wireless communication apparatus via a wireless channel. The wireless communication apparatus 200 includes a physical layer 210 that is a processing unit which performs processing in a physical layer for achieving the wireless communication; and a MAC layer 220 that is processing unit in the MAC layer. The physical layer 210 and the MAC layer 220 may be realized as an analog or digital circuit, etc., and may be realized through software to be carried out by a CPU. An antenna 201 is connected to the physical layer 210. The antenna 201 is composed of one or more antennas in response to a communication system to be established. In this embodiment, the antenna 201 includes two antenna units.

The physical layer 210 performs physical layer protocol processing so as to achieve the communication system to be established, and includes a transmission unit 211 which transmits a frame to be transferred from the MAC layer 220 to a wireless channel; and a reception unit 212 which performs processing of a wireless signal received from the antenna 201.

The reception unit 212 includes a low noise amplifier (LNA) amplifying a reception signal from an antenna; and a frequency converter (down converter) which converts a frequency of an amplified signal into an intermediate frequency or a baseband frequency. The reception unit 212 further includes an analog to digital converter (ADC) which converts a frequency converted analog signal into a digital signal; and a demodulation unit which performs reception processing including demodulation and decoding processing to the digital signal in accordance with a physical layer protocol to transfer the MAC frame to the MAC layer 220.

Meanwhile, the transmission unit 211 includes a modulation unit which performs transmission processing including modulation and coding processing for the MAC frame transferred from the MAC layer 220 in accordance with the physical layer protocol; and digital to analog converter (DAC) which converts a digital signal from the modulation unit into an analog signal. The transmission unit 211 further includes a wireless unit which up-converts the converted analog baseband signal into a prescribed frequency band (e.g., 2.4, 5 GHz, etc.) to transmit the converted signal from the antenna as a wireless signal.

The physical layer protocol to be established in the physical layer 210 is not limited to one kind of physical layer protocol, and may be configured so as to correspond to two or more kinds of physical layer protocols. On the wireless communication apparatus 200, for instance, a physical layer protocol defined in the IEEE 802.11n standard may be established, and furthermore, a physical layer protocol defined in the IEEE 802.11a, 802.11g, and 802.11b standards may be established.

The MAC layer 220 performs MAC layer protocol processing in order to achieve communication processing to be established in the MAC layer 220, and includes a received frame bitmap information storage unit 221; a Block Ack frame generation unit 222; a received frame analysis unit 223; a TID bitmap storage unit 224; and a bitmap reset determination unit 225.

When normally receiving the MAC frame in which the transmitting MAC address and the TID coincide with each other, the information storage unit 221 stores a bitmap showing the success of the reception. The information storage unit 221 further stores the MAC address of the transmitting wireless communication apparatus corresponding to the delivery acknowledgement information of the received MAC frame to be stored therein.

The Block Ack frame generation unit 222 generates the Block Ack frame by using the delivery acknowledgement information stored in the information storage unit 221. The Block Ack frame generated from the generation unit 222 is replied through the transmission unit 211. The received frame analysis unit 223 analyzes the frame to be transferred from the physical layer 210. The information on the MAC frame information acquired from the frame analysis result is supplied to the storage unit 221, the generation unit 222 and the determination unit 225.

The storage unit 224 stores the TID to which the ADDBA has established in the bitmap form. The determination unit 225 determines whether or not the storage unit 221 should be reset or not on the basis of the analysis result from the analysis unit 223 and the information from the storage unit 224. Based on the determination result, reset control of the delivery acknowledgement information preliminarily stored in the storage unit 221 is implemented.

An example of operations in the wireless LAN system shown in FIG. 1 will be described hereinafter. While the case in which the wireless base station 101 transmits frames to the wireless terminals 102 will be described as the example, conversely, the case in which the wireless terminal 102 transmits the frames to the wireless station 101 is implemented similarly.

The frame to be used for the communication between the wireless base station 101 and the wireless terminal 102 may be a kind of control frame at the MAC frame in IEEE 802.11 standards, and may be a management frame or a data frame.

Hereinafter, a reset determination method of a received frame bitmap stored in the wireless base station 101 in a case where the wireless terminal 102 continuously transmits the plurality of MAC frames to receive the Block Ack frame including the delivery acknowledgement information of the plurality of MAC frames from the wireless base station 101, and after this, the wireless base station 101 receives the MAC frames from the wireless terminal 103 will be described.

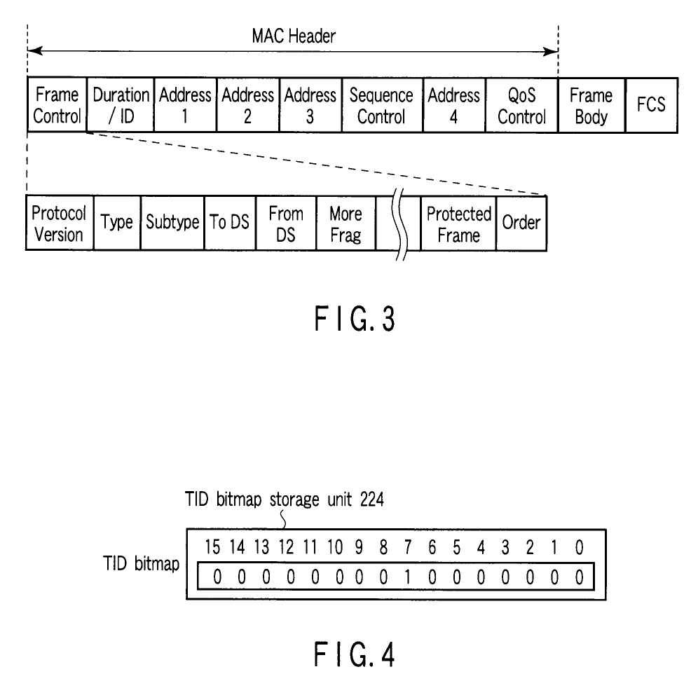

FIG. 3 shows a configuration of a MAC frame to be used in the wireless LAN system in IEEE 802.11 standards. The MAC frame consists of a MAC Header, a Frame body and a Frame Check Sequence (FCS). In the MAC Header, information which is necessary to perform reception processing in the MAC layer is set. In the Frame body, information (data, etc., from a higher order layer) corresponding to a kind of the MAC frame is set. In the FCS, a cyclic redundancy code (CRC) to be used for determining whether or not the MAC Header and the Frame Body have been normally received is set.

The MAC Header includes a Frame Control field to which a value according to the kind of the frame; a Duration/ID field showing a transmission standby period (network allocation vector [NAV]); address fields (existing as a plural) setting the MAC addresses of a direct destination apparatus; a final destination apparatus and a transmitting apparatus; a sequence number of the data to be transmitted; and a Sequence Control field setting a fragment number when the data is fragmentized, etc. The Frame Control field includes a Type field and a Subtype field indicating a kind of a frame; a More Fragment bit, etc., indicating the existence of the following fragment frame when the data is fragmentized, etc.

The bit line to be set in the Type field enables determining which of the frame types among a control frame, a management frame and a data frame includes the frame.

Further, the bit line in the Subtype field indicates the kind of the Mac frame in each frame type. For instance, if it is determined that the kind of the MAC frame is the data frame by means of the Type field in the normally received frame, the further acknowledgement of the bit line to be set in the Subtype field makes it possible to determine whether the frame is QoS Data or non-Qos Data.

The QoS Data is, as shown in a frame format in FIG. 3, a Data frame including the QoS Control field and being used also for the Block Ack mechanism.

Meanwhile, the non-QoS data does not include the QoS Control field, and is the Data frame not to be used in the Block Ack mechanism. Accordingly, as a result of the acknowledgement of the Subtype field, if it is determined that the Data frame is the non-Qos data; it becomes clear that at least the frame is not one transmitted in the Block Ack mechanism.

Conversely, if it is determined that the Data frame is the QoS Data, it becomes clear that the QoS Control field is added to the last of the MAC Header. The QoS Control field includes the TID field (16 kinds from 0-15 exist) to which identifiers corresponding to traffic of the data and Ack policy fields to which the delivery acknowledgement systems are set, etc.

Acknowledging the TID field enables recognizing a traffic type of data, and acknowledging the Ack policy fields enables determining the policy which has transmitted the QoS Data among a Normal Ack policy, a Block Ack policy, or a No Ack policy.

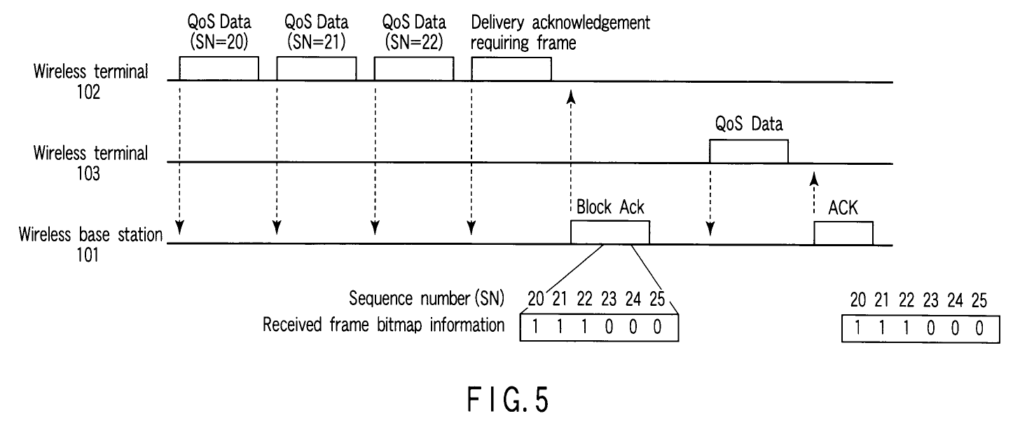

After the wireless terminal 102 continuously transmits the plurality of MAC frames to the wireless base station 101, finally transmits the frame requiring the delivery acknowledgement, and then, receives the Block Ack frame from the wireless base station 101. FIG. 5 shows an example in which after completing the sequence, the wireless terminal 103 transmits the QoS Data frame to the wireless base station 101 and receives an ACK.

When transmitting the QoS Data to the wireless base station 101 by using the Block Ack mechanism, the wireless terminal 102 exchanges prescribed frames to and from the wireless base station 101 in advance and establishes the negotiation (ADDBA) for the Block Ack mechanism in advance. With the ADDBA, the wireless base station 101 may ascertain the QoS Data of the TID to which the wireless terminal 102 should apply the Block Ack mechanism. The wireless base station 101 stores the TID ascertained in this ADDBA in the TID bitmap storage unit 224 in a bitmap form of 16-bit. For instance, if it is decided to use the Block Ack mechanism for the QoS Data frame of which the TID is “7”, the TID bitmap storage unit 224 stores TID bitmap information “0000000010000000 (wherein, the right end is set to as a LSB)” of 16-bit in which “1” is set to the eighth bit from the LSB, as shown in FIG. 4. Meanwhile, as regards the TID of the QoS Data in which the ADDBA has not been established, “0” is set and “0” is stored in the storage unit 224.

When receiving the plurality of MAC frames from the wireless terminal 102, the wireless base station 101, as shown in FIG. 5, transmits the Block Ack frame including delivery acknowledgement bitmap information showing whether or not each MAC frame can be normally received. The Block Ack frame includes a starting point sequence number and a bitmap field setting “0” or “1” as a reception record. The wireless base station 101 reports a previous MAC frame reception record of which the starting point sequence number is set as a starting point to the bitmap field by setting “0” or “1” from the head of the Frame. For instance, when the wireless base station 101 normally receives the MAC frame, the base station 101 sets “1” at a bit position in the bitmap field corresponding to the sequence number of the MAC frame, and sets “0” at a bit position in the bitmap field corresponding to the sequence number of the MAC frame which has not been received.

In the sequence shown in FIG. 5, when normally received all three pieces of the QoS Data of which the sequence number (SN) is 20 to 22 from the wireless terminal 102, the wireless base station 101 sets “20” in the starting point sequence number field included in the Block Ack frame and sets “111000” in the bitmap field. The head bit of the bitmap field indicates the reception of the QoS Data of the sequence number 20, and the wireless base station 101 sets the numbers 21, 22 step by step from the head bit. Since the QoS Data at the number 23 or latter have not been received, “0” are set in the bitmap field. The sequence number of the QoS Data may be recognized by acknowledging the Sequence Control field included in the MAC Header of the received frame.

The bit line to be set in the bitmap field included in the Block Ack frame is stored in the storage unit 221 of the wireless communication apparatus 200. While the embodiment has been described in the example in which the bitmap field has a 6-bit length, the invention is not limited to the 6-bit length. The length of the bitmap field may be 16 bits or 64 bits.

The wireless base station 101 does not transmit the ACK frame to individual QoS Data to be transmitted from the wireless terminal 102. The wireless base station 101 acknowledges the Ack policy in the QoS Control field included in the MAC Header of the received QoS Data, and when the Ack policy is a “Block Ack policy” or a “No Ack policy”, the wireless base station 101 does not transmit the ACK frame.

Meanwhile, the wireless base station 101 transmits the ACK frame to the QoS Data to be transmitted from the wireless terminal 103. In this case, as is similar to the aforementioned case, the wireless base station 101 acknowledges the received Ack policy in the QoS data, and if it is the “Normal Ack policy”, the base station 101 transmits the ACK frame.

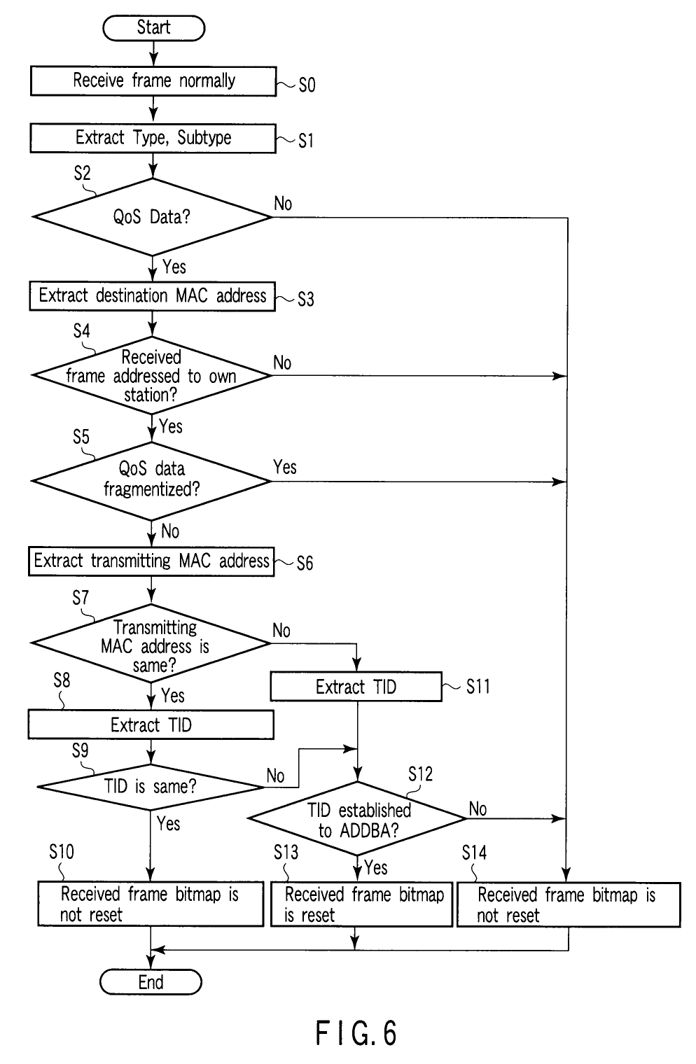

In this way, at the time point when the wireless base station 101 has transmitted the Block Ack frame to the wireless terminal 102, the bitmap of the received frame stored in the wireless base station 101 is the delivery acknowledgement information related to the wireless terminal 102. After this, a method for controlling whether or not the bitmap information stored in the wireless base station 101 should be reset in accordance with the MAC Header information of the frame received from the wireless terminal 103 when the QoS Data has been received from the wireless terminal 103 will be described by referring to a flowchart shown in FIG. 6 hereinafter.

The wireless terminal 102 firstly transmits the plurality of items of QoS Data continuously; further transmits the delivery acknowledgement requiring frame, and after this, the wireless base station 101 transmits the Block Ack frame to the wireless terminal 102. After this, the wireless base station 101 normally receives the frame from the wireless terminal 103 (Step S0 in FIG. 6). At this moment, since the received frame analysis unit 223 of the wireless base station 101 stores the MAC Header of the received MAC frame, the bitmap reset determination unit 225 may determine the reset of the bitmap information in accordance with the flowchart shown in FIG. 6.

The wireless base station 101 extracts the Type and the Subtype from the MAC Header of the MAC frame (Step S1). The base station 101 acknowledges the Type and the Subtype included in the MAC Header to determine whether or not the MAC frame is the QoS Data (Step S2). As a result of the determination, if the received MAC frame is the QoS Data, a destination MAC address is extracted from the MAC Header (Step S3). The base station 101 compares the extracted destination MAC address with the MAC address of the base station 101 to determine whether they coincide with each other (Step S4).

As a result of the determination in the step S4, if the destination MAC address coincides with the MAC address of the wireless base station 101 (in this case, the MAC frame is referred to that the QoS Data is addressed to own station), it is determined whether or not the QoS Data is fragmentized (Step S5). The case in which the QoS Data is fragmentized into a plurality of small pieces of data means a case in which at least any one of a case where a More Fragment bit is “1”, or a case where a fragment number in the Sequence Control field is other than “0” is established.

As a result of the determination in Step 5, if the received QoS Data has not been fragmentized, transmitting MAC address is extracted from the MAC Header (Step S6). The base station 101 compares the extracted transmitting MAC address with the transmitting MAC address of the received frame bitmap information currently stored in the storage unit 221 to determine whether or not they coincide with each other (Step S7).

As a result of the determination in Step S7, if the transmitting MAC addresses coincide with each other, the TID included in the QoS Control field of the MAC Header is extracted (Step S8). The base station 101 compares the extracted TID with the TID of the received frame bitmap information currently stored in the received frame bitmap storage unit 221 to determine whether they coincide with each other or not (Step S9).

As a result of Step S9, if the two TIDs coincide with each other, the wireless base station 101 recognizes that the QoS Data addressed to own station having the same TID has received from the same transmitting MAC address as that of the received frame bitmap information currently stored in the storage unit 221. In this case, the bitmap information currently stored in the storage unit 221 is not reset (Step S10).

If it is determined “No” in Step S2, namely if the frame received by the base station 101 is not the QoS Data, the frame is not a frame to be recorded in the received frame bitmap information. In this case, the base station 101 does not reset the received frame bitmap information stored in the storage unit 221 (Step S14).

In Step S4, if the destination MAC address extracted from the MAC Header does not coincide with the MAC address of the wireless base station 101 (if they do not coincide with each other, a broadcast address or a multicast address is also included); the frame is not a frame to be recorded in the received frame bitmap information. Therefore, the base station 101 does not reset the bitmap information stored in the storage unit 221 (Step S14).

In Step S5, if the received QoS Data has been fragmentized, the frame is not a frame to be recorded in the received frame bitmap information. In this case, the bitmap information stored in the storage unit 221 of the wireless base station 101 is not reset (Step S14). But, in this embodiment, the frame in which the QoS Data has been fragmentized is determined as the frame not to be recorded in the received frame bitmap information. However, in a case in which the fragmentized frame is made as the frame to be recorded in the bitmap information, a branching condition in Step S5 is not necessary.

In step S7, if the transmitting MAC address extracted from the MAC Header and the transmitting MAC address of the received frame bitmap information currently stored in the received frame bitmap storage unit 221 do not coincide with each other, the TID included in the QoS Control field of the MAC Header is extracted (Step S11). It is determined whether or not the extracted TID is the TID to which “1” has been set in the TID bitmap stored in the TID bitmap storage unit 224 (whether or not the extracted TID to which the ADDBA has been established) (Step S12).

As a result of Step S12, if it is determined that the TID is one to which “1” has been set in the TID bitmap, namely the TID is one to which the ADDBA has been established by the wireless base station 101, there is a need to recognize that the wireless base station 101 has received the QoS Data of the TID to which the ADDBA has been established from the wireless terminal of the transmitting MAC address differing from the received frame bitmap information currently stored in the storage unit 221, and to newly generate the received frame bitmap information. In this case, the bitmap information currently stored in the storage unit 221 is reset (Step S13).

If it is determined “No” in Step S12, it is determined that the TID extracted from the received MAC frame is the TID to which “1” has not been set in the TID bitmap stored in the TID bitmap storage unit 224, and that the TID to which the ADDBA has not been established by the wireless base station 101. In this case, since the received QoS Data is not a frame which has been established the ADDBA so as to start the Block Ack mechanism, the received frame bitmap information currently stored in the storage unit 221 of the wireless base station 101 is not reset (Step S14).

In Step S9, if two TIDs do not coincide with each other, the received frame has been received from the wireless terminal of the transmitting MAC address having the same address as that in the bitmap information currently stored in the storage unit 221. However, in this case, it is recognized that the wireless base station 101 has received the QoS Data differing in TID; the wireless base station 101 performs the processing from Step S12 to Step S14, and decides whether or not to reset the bitmap information currently stored in the storage unit 221.

In the sequence shown in FIG. 5, in a case in which the wireless base station 101 has received the QoS Data (it is assumed that the TID, in the QoS Control field, to which the ADDBA has not been established) from the wireless terminal 103, the wireless base station 101 implements processing from Step S0 to Step S7, and processing from Step S11 to Step S12. In this case, the TID included in the QoS Data received from the wireless terminal 103 in Step S12 is not the TID to which the ADDBA has been established. Therefore, the received frame bitmap information stored in the wireless base station 101 is not reset.

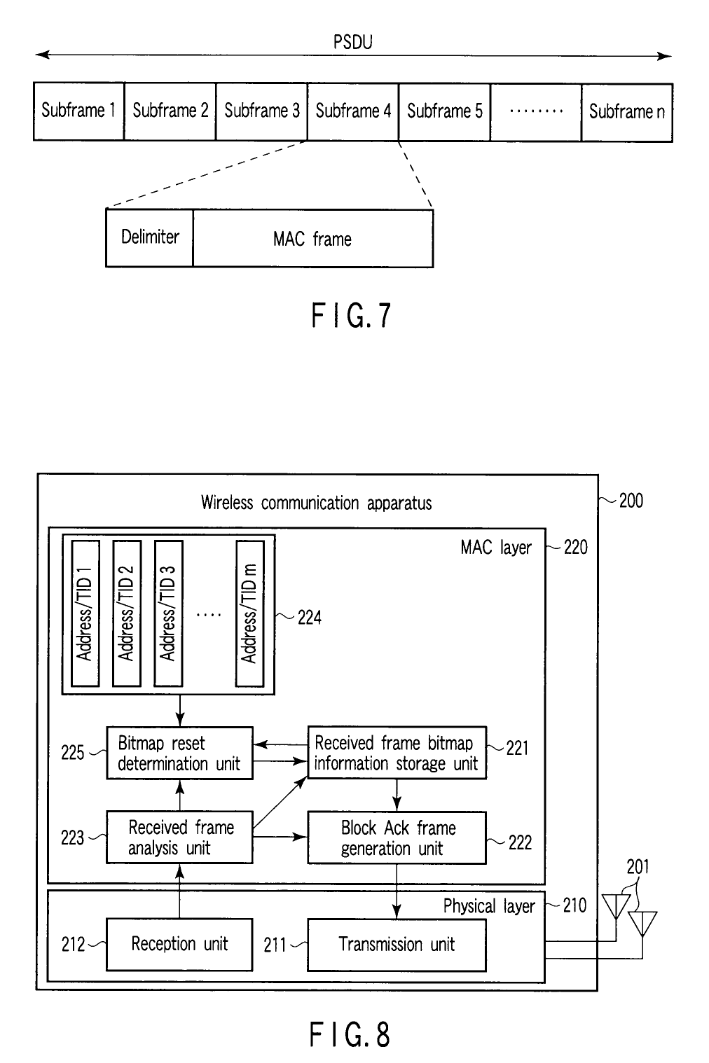

FIG. 7 shows a configuration example of an Aggregation frame in which a plurality of MAC frames are included in a single PLCP service data unit (PSDU). A PSDU frame is composed of a frame in which n pieces of Subframes (n is a positive integer) are coupled. Each Subframe is composed of a Delimiter field for detecting boundaries of the Subframe and a MAC frame. The Delimiter field includes information showing the lengths of the following MAC frames, a CRC for detecting an error of the length information, and a bit line for identifying that the field is a Delimiter.

In the example of the sequence shown in FIG. 5, the wireless terminal 102 transmits a plurality of MAC frames to the wireless base station 101 at intervals. However, the wireless terminal 102 may transmit the plurality of MAC frames as an Aggregation frame which aggregates the plurality of MAC frames in the frame format shown in FIG. 7 into one. Even in such a case, a received frame analysis unit may perform reset determination of the bitmap information in a similar way to a case of reception of the plurality of MAC frames by disaggregating the Aggregation frame into individual MAC frames.

In a conventional reset method, the stored received frame bitmap information is reset at a time point at which the wireless base station 101 has recognized the change in transmitting MAC address (in FIG. 5, at a time point when the transmitting wireless terminal has been switched from the wireless terminal 102 to the wireless terminal 103). However, like the flowchart shown in FIG. 6, by performing acknowledgement processing of the TID to which the ADDBA has been established, the useless reset of the reception of the frame bitmap is avoided. When the frame has been received again from the wireless terminal 102, since the wireless base station 101 may reply the bitmap information which has not been reset, the avoidance of the above is efficient.

To avoid the useless reset of the bitmap information, a configuration of the wireless communication apparatus 200 as shown in FIG. 8 so as to store the whole of the MAC addresses of the wireless terminals of which the ADDBAs have been established is a possible approach. In this case, there is a need to store MAC addresses of a plurality of wireless terminals and m (m is a positive integer larger than zero) pieces of information of the TID in the TID bitmap storage unit 224, and it results in increase in circuit scale. Further, the processing of retrieving the MAC addresses of the relevant wireless terminals and the TIDs becomes complicated.

In the sequence shown in FIG. 5, since the wireless base station 101 replies the Block Ack frame to the wireless terminal 102, the delivery acknowledgement of the frames which have been received by the wireless base station 101 till then has been completed. In a case in which the wireless terminal 102 has not normally received the Block Ack, if the wireless base station 101 has reset the bitmap information on the basis of the reception from the wireless terminal 103, the delivery acknowledgment information of the wireless terminal 102 is erased, and the wireless terminal 102 has to retransmit the same frame.

The wireless communication apparatus of the embodiment may reduce the frequency to uselessly reset the received frame bitmap information by acknowledging the bitmap of the TID to which the ADDBA has been established, may reduce the useless communication to shorten the communication time period, and the throughput of the wireless communication apparatus is improved.

There is no need to manage a plurality of the MAC addresses of the transmission terminals in which the ADDBAs have been established and a plurality of items of information of the TIDs, and since the circuit scale may be reduced, in a case of achievement of a circuit by means of an integrated circuit, the size of an IC chip may be reduced and a manufacturing cost and consumed power may be decreased.

### SECOND EMBODIMENT

A second embodiment will be described hereinafter. The wireless communication apparatus of a second embodiment differs from that of the first embodiment in a point that includes N (N is an integer of two or more) received frame bitmap information storage units.

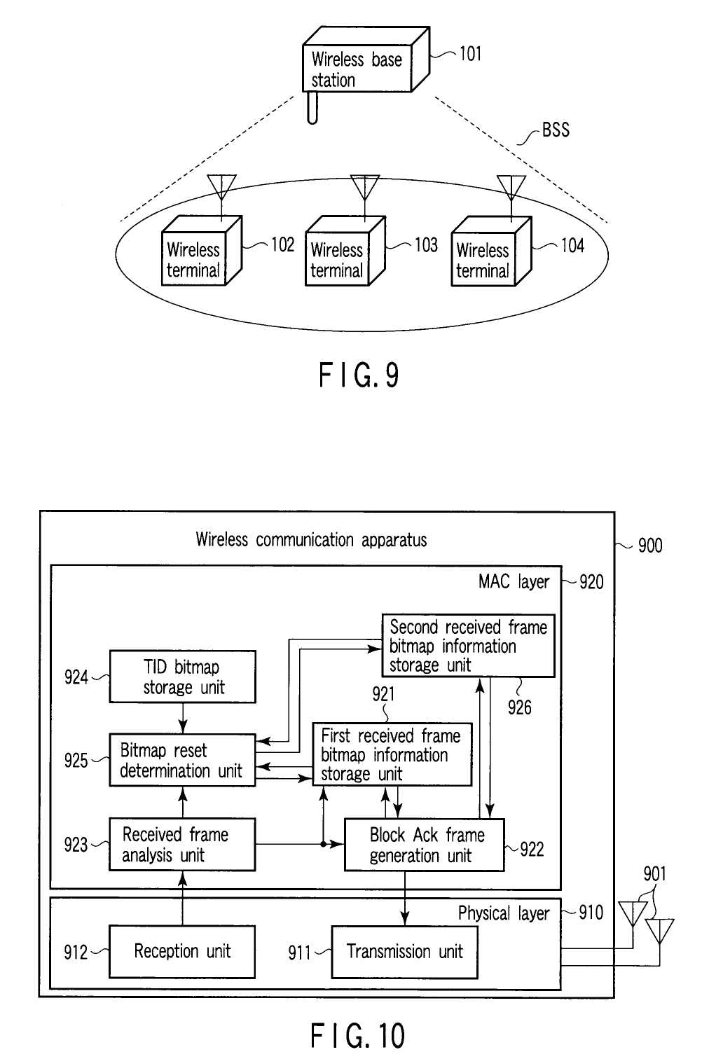

A wireless LAN system to which such a wireless communication apparatus is applied will be described in FIG. 9. In the wireless LAN system of FIG. 9, a BSS including a wireless terminal 104 in addition to the wireless base station 101, wireless terminal 102, wireless terminal 103 shown in FIG. 1.

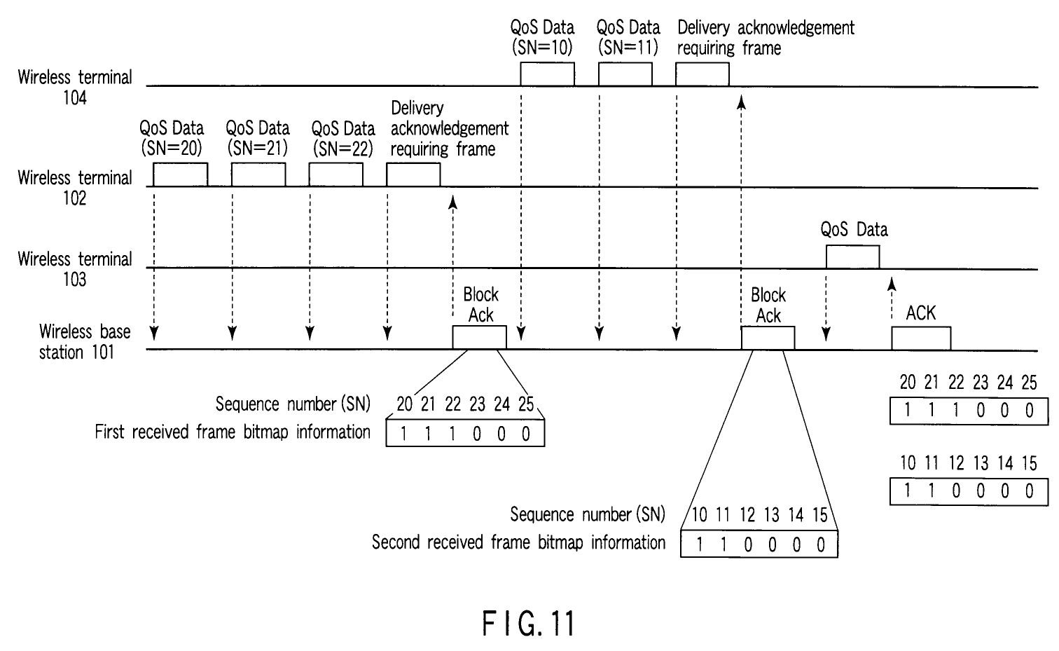

FIG. 10 shows a block diagram illustrating a configuration of the wireless communication apparatus of the second embodiment of the invention. A wireless communication apparatus 900 includes a physical layer 910, a MAC layer 920, an antenna 901, a transmission unit 911, a reception unit 912, a first received frame bitmap information storage unit 921, a Block Ack frame generation unit 922, a received frame analysis unit 923, a TID bitmap storage unit 924, a bitmap reset determination unit 925 corresponding to symbols 210, 220, 201, 211, 212, 221, 222, 223, 224 and 225 in FIG. 2, respectively and further includes a second received frame bitmap information storage unit 926. This example shows an example in which the number N of the received frame information storage units is two. However, the number of the storage units is not limited to two.

In comparison with the wireless communication apparatus 200 of the first embodiment, the second received frame bitmap information storage unit 926 is added to the wireless communication apparatus 900 of the second embodiment, and the bitmap reset determination unit 925 determines the reset of the first received frame bitmap information storage unit 921 and the second received frame bitmap information storage unit 926.

The following will mainly describe the difference points from the first second embodiment. At first, an example of a frame sequence implemented among the wireless base station 101 and the wireless terminals 102, 103, 104 will be described. The wireless terminal 102 continuously transmits a plurality of MAC frames to the wireless base station 101, and after finally transmitting a frame requesting for delivery acknowledgment, the wireless terminal 102 receives a Block Ack frame from the wireless base station 101. After completion of this sequence, the wireless terminal 104 continuously transmits a plurality of MAC frames to the wireless base station 101, then after finally transmitting a frame requesting for delivery acknowledgment, the wireless terminal 104 receives a Block Ack frame from the wireless base station 101. An example of a frame sequence in which, after the sequence of the above, the wireless terminal 103 transmits a QoS Data frame to the wireless base station 101 will be shown in FIG. 11.

In the frame sequence shown in FIG. 11, the wireless terminal 102 and wireless terminal 104 each transmit the QoS Data to the wireless base station 101 by using the Block Ack mechanism. Therefore, prescribed frame exchanges are performed to and from the wireless base station 101 in advance, and a negotiation (ADDBA) for the Block Ack has been established in advance. The ADDBA enables ascertaining that the wireless terminals 102 and wireless terminal 104 should apply the Block Ack mechanism to the QoS Data of TID, respectively. The ascertained TIDs in this ADDBA are stored as data in a 16-bit bitmap format in the TID bitmap storage unit 924. For instance, it is assumed that it is decided for the wireless terminal 102 to use the Block Ack mechanism for transmitting the QoS DATA frame of which the TID is “7”, and for the wireless terminal 104 to adopt the Block Ack mechanism for the QoS Data frame of which the TID is “8”. In this case, 16-bit TID bitmap information “0000000110000000” in which “1” is set to the eighth and the ninth bits from the LSB is stored in the TID bitmap storage unit 924. Meanwhile, “0” is set to the TID bitmap for the TID of the QoS Data in which the ADDBA has not been established.

When each receiving a plurality of the MAC frames from the wireless terminals 102, 104, the wireless base station 101 transmits the Block Ack frame including delivery acknowledgment bitmap information showing whether or not each MAC frame has been normally received after receiving the delivery acknowledgment requiring frame.

When all the three items of QoS Data from the sequence number (SN) of “20” to “22” have been normally received from the wireless terminal 102, the wireless base station 101 sets “20” in a starting point sequence number field included in the Block Ack frame, and sets “111000” in the bitmap field.

Meanwhile, when normally receiving all the two pieces of QoS data of the sequence numbers (SNs) from “10” to “11”, the wireless base station 101 sets the number “10” in the starting point sequence number field included in the Block Ack frame, and sets “110000” in the bitmap field. The bit line to be set in the bitmap field included in the Block Ack frame to be transmitted from the wireless terminal 102 is stored in the first reception bitmap information storage unit 921 of the wireless communication apparatus 900.

Meanwhile, the bit line for the wireless terminal 104 is stored in the second reception bitmap information storage unit 926. While the aforementioned description has been described the example of the case in which the bitmap fields to be stored in the first and second reception bitmap information storage units 921, 926 each have 6-bit lengths, the length of the bitmap field of the invention is not limited to the six bits. The length of the bitmap field may be 16 bits or 64 bits.

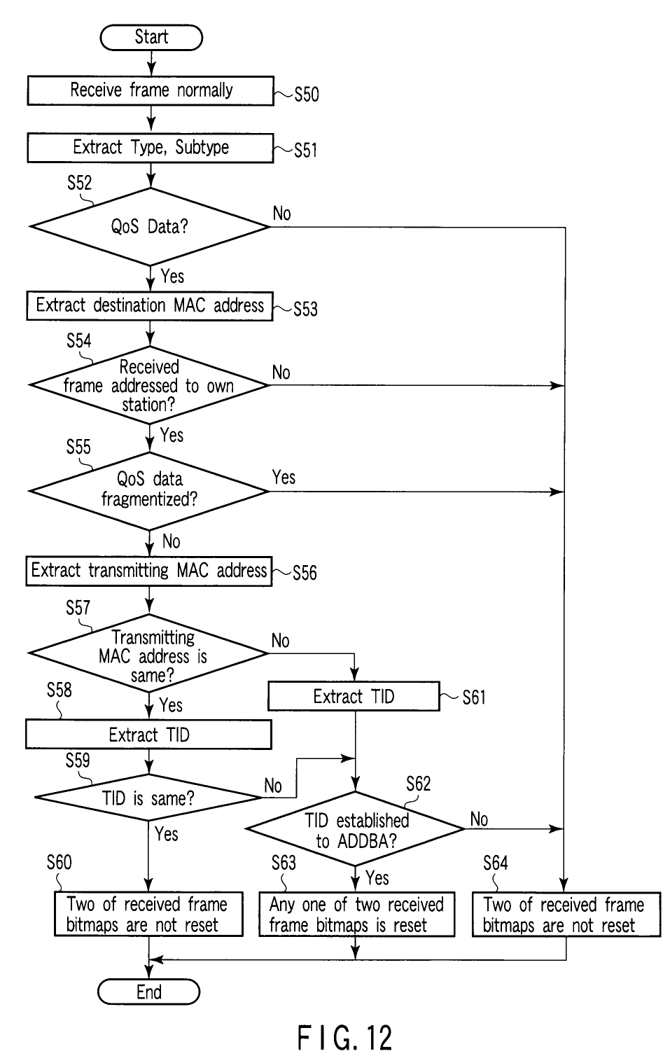

In this way, at a time point when the wireless base station 101 transmits each Block Ack frame to the wireless terminals 102, 104, the bitmap of the received frame is the delivery acknowledgment information related to the wireless terminals 102, 104. After this, a method for controlling whether the bitmap information stored in the wireless base station 101 should be reset or not in accordance with the MAC Header information of the received frame when receiving the QoS Data from the wireless terminal 103 will be described hereinafter with reference to a flowchart in FIG. 12.

The wireless terminal 102 firstly transmits a plurality of items of the QoS Data continuously to the wireless base station 101, and the wireless base station 101 transmits the Block Ack frame to the wireless terminal 102. Further, the wireless terminal 104 continuously transmits the plurality of items of QoS Data to the wireless base station 101, and the wireless base station 101 transmits the Block Ack frame to the wireless terminal 104. After this, the wireless base station 101 normally receives a frame from the wireless terminal 103 (Step S50). At this time, the received frame analysis unit 923 of the wireless base station 101 has stored the MAC Header of the received MAC frame; using the stored MAC Header enables the bitmap reset determination unit 925 to perform reset determination of the bitmap information in accordance with a flowchart of FIG. 12.

Since the processing from Step S50 to Step S56 in FIG. 12 is the same as that from Step S0 to Step S6 shown in FIG. 6, the description for the processing will be omitted. In this embodiment, as is like the case of FIG. 6, the frame in which the QoS Data has been fragmentized is not set as a frame to be recorded in the received frame bitmap information. However there is no need of a branching condition of Step S55 in a case in which the fragmentized frames are set to the frames to be recorded in the received frame bitmap.

At first, the processing in Step S57 will be described hereinafter. In Step S56, the transmitting MAC address extracted from the MAC Header is compared with the transmitting MAC addresses of each item of the received frame bitmap information currently stored in the first or second received frame bitmap storage unit 921, 926, and it is determined that they coincide with one another or not (Step S57).

As the determination result in Step S57, in a case in which the transmitting MAC address coincides with the MAC address stored at least any one of the first received frame bitmap storage unit 921 or the second received frame bitmap storage unit 926, the TID included in the QoS Control field of the MAC Header is extracted (Step S58).

The extracted TID and the TID of the received frame bitmap information currently stored in the first or second received frame bitmap storage unit 921 or 926 are compared, respectively, to be determined whether they coincide one another or not (Step S59).

As a result of Step S59, in a case in which the TID extracted from the MAC Header coincides with at least any one of the TID stored in the first or second received frame bitmap storage unit 921 or 926, the bitmap information currently stored in the first and second received frame bitmap storage units 921, 926 are not reset (Step S60).

In a case in which it is determined “No” in the branching processing in Step S52 or S54, and a case in which it is determined “Yes” in Step S55, the bitmap information currently stored in the first and second received frame bitmap storage units 921, 926 are not reset (Step S64).

In Step S57, in a case where the transmitting MAC address extracted from the MAC Header does not coincide with neither the transmitting MAC address of the received frame bitmap information currently stored in the first received frame bitmap storage unit 921 nor in the second received frame bitmap storage unit 926, the TID included in the QoS Control field of the MAC Header is extracted (Step S61).

It is determined whether or not the extracted TID is the TID set as “1” in the TID bitmap stored in the TID bitmap storage unit 924 (Step S62).

As the determination result in Step S62, in a case in which it is determined that the extracted TID is the TID set as “1” in the TID bitmap, namely that the extracted TID is the TID to which the ADDBA has been established by the wireless base station 101, the bitmap information will be processed as follows. That is, any one of the bitmap information currently stored in the first received frame bitmap storage unit 921 and the second received frame bitmap storage unit 926 is reset (Step S63). While there are many cases which of the items of bitmap information are reset, a concept of the embodiment is not to select the bitmap information, but to decide whether the bitmap information is reset or not. Thus, a method for selecting which of the plurality of items of bitmap information is not limited particularly, and the selection may be decided, for example, at random.

In Step S62, in a case it is determined “No”, that is, in a case in which the TID extracted from the received MAC frame is the TID which has not been set as “1” in the TID bitmap stored in the TID bitmap storage unit 924, and a case in which it is determined the extracted TID is the TID of which the ADDBA has not been established by the wireless base station 101, the extracted TID will be processed as follows. That is, the two pieces of the received frame bitmap information currently stored in the first and second received frame bitmap storage units 921, 926 of the wireless base station 101 are not reset (Step S64).

In Step S59, if it is determined “No”, the processing from Step S62 to Step S64 are implemented, it is decided whether or not the bitmap information currently stored in the first and second received frame bitmap storage units 921, 926 should be reset.

In the sequence shown in FIG. 11, in a case in which the wireless base station 101 receives the QoS Data (it is assumed that the TID in the QoS Control field has not established the ADDBA) from the wireless terminal 103, the processing from Step S50 to Step S57 and the processing from the Step S61 to Step S62 are performed. In this case, the TID included in the QoS Data received from the wireless terminal 103 in Step S62 is not the TID to which the ADDBA has not been established. Therefore, the wireless base station 101 does not reset both the stored two items of the received frame bitmap information.

As mentioned above, according to this embodiment, since the TID bitmap storage unit has been provided for the wireless communication apparatus, even when a plurality of received frame bitmap storage units are provided for the wireless communication apparatus, it is able to determine whether the received frame bitmap information should be reset or not. Thus, acknowledging the bitmap of the TID to which the ADDBA has been established enables avoiding useless reset of the received frame bitmap information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a received frame analysis unit which analyses a received MAC frame including MAC Header information;
a received frame bitmap information storage unit which stores delivery acknowledgment information of the received MAC frame on the basis of the MAC Header information analyzed by the received frame analysis unit; and
a bitmap reset determination unit which determines whether or not the delivery acknowledgement information of the received MAC frame stored in the received frame bitmap information storage unit should be reset on the basis of the MAC Header information of the received MAC frame analyzed by the received frame analysis unit, the received frame bitmap information storage unit being controlled the reset in accordance with the determination result.

2. The wireless communication apparatus according to claim 1, wherein
the bitmap reset determination unit determines that the delivery acknowledgment information stored in the received frame bitmap information storage unit should not be reset when the received MAC frame analyzes by the received frame analysis unit is a MAC frame addressed to own apparatus and when the received MAC frame is not a frame of a specified frame type.

3. The wireless communication apparatus according to claim 1, further comprising:
a Block ACK frame generation unit which generates a delivery acknowledgement response frame including the delivery acknowledgement information of the received MAC frame stored in the received frame bitmap information storage unit on the basis of a delivery acknowledgement request when a delivery acknowledgement request frame has been analyzed by the received frame analysis unit.

4. The wireless communication apparatus according to claim 1, further comprising:
a traffic ID (TID) bitmap storage unit which stores a TID of a frame allowing the received frame bitmap information storage unit to store the delivery acknowledgement information, wherein
the bitmap reset determination unit determines whether or not the delivery acknowledgment information of the received MAC frame stored in the received frame bitmap information storage unit should be reset on the basis of the TID stored in the TID bitmap storage unit in addition to the MAC Header information of the received MAC frame analyzed by the received frame analysis unit.

5. The wireless communication apparatus according to claim 4, wherein
the received frame bitmap information storage unit further stores a MAC address, being analyzed by the received frame analysis unit, of a transmitting wireless communication apparatus corresponding to the delivery acknowledgement information of the received MAC frame to be stored therein;
the bitmap reset determination unit determines that the delivery acknowledgement information of the received MAC frame stored in the received frame bitmap information storage unit should not be reset
when the received MAC frame analyzed by the received frame analysis unit is a frame addressed to own apparatus and the received MAC frame is a frame of a specified frame type; and
when a transmitting MAC address of the received MAC frame and a TID of the received MAC frame coincide with the MAC address stored in the received frame bitmap information storage unit and a TID corresponding to the MAC address stored in the received frame bitmap information storage unit, respectively.

6. The wireless communication apparatus according to claim 4, wherein
the received frame bitmap information storage unit further stores a MAC address, being analyzed by the received frame analysis unit, of a transmitting wireless communication apparatus corresponding to the delivery acknowledgement information of the received MAC frame to be stored therein;
the bitmap reset determination unit determines that the delivery acknowledgement information of the received MAC frame stored in the received frame bitmap information storage unit should be reset
when the received MAC frame analyzed by the received frame analysis unit is a frame addressed to own apparatus and the received MAC frame is a frame of a specified frame type;
when a transmitting MAC address of the received MAC frame and the MAC address stored in the received frame bitmap information storage unit coincide with each other;
when a TID of the received MAC frame and a TID corresponding to the MAC address stored in the received frame bitmap information storage unit do not coincide with each other; and
when a TID of the received MAC frame coincides with a TID stored in the TID bitmap storage unit.

7. The wireless communication apparatus according to claim 4, wherein the received frame bitmap information storage unit further stores a MAC address, being analyzed by the received frame analysis unit, of a transmitting wireless communication apparatus corresponding to the delivery acknowledgement information of the received MAC frame to be stored therein; and
the bitmap reset determination unit determines that the delivery acknowledgement information of the received MAC frame stored in the received frame bitmap information storage unit should not be reset
when the received MAC frame analyzed by the received frame analysis unit is a frame addressed to own apparatus and the received MAC frame is a frame of a specified frame type;
when a transmitting MAC address of the received MAC frame and the MAC address stored in the received frame bitmap information storage unit coincide with each other;
when a TID of the received MAC frame and a TID corresponding to the MAC address stored in the received frame bitmap information storage unit do not coincide with each other; and
when a TID of the received MAC frame does not coincide with a TID stored in the TID bitmap storage unit.

8. The wireless communication apparatus according to claim 4, wherein the received frame bitmap information storage unit further stores a MAC address, being analyzed by the received frame analysis unit, of a transmitting wireless communication apparatus corresponding to the delivery acknowledgement information of the received frame to be stored therein; and
the bitmap reset determination unit determines that the delivery acknowledgement information of the received MAC frame stored in the received frame bitmap information storage unit should be reset
when the received MAC frame analyzed by the received frame analysis unit is a frame addressed to own apparatus and the received MAC frame is a frame of a specified frame type;
when a transmitting MAC address of the received MAC frame and the MAC address stored in the received frame bitmap information storage unit do not coincide with each other; and
when a TID of the received MAC frame coincides with a TID stored in the received frame bitmap information storage unit.

9. The wireless communication apparatus according to claim 4, wherein the received frame bitmap information storage unit further stores a MAC address, being analyzed by the received frame analysis unit, of a transmitting wireless communication apparatus corresponding to the delivery acknowledgement information of the received MAC frame to be stored therein; and
the bitmap reset determination unit determines that the delivery acknowledgement information of the received frame stored in the received frame bitmap information storage unit should not be reset
when the received MAC frame analyzed by the received frame analysis unit is a frame addressed to own apparatus and the received MAC frame is a frame of a specified frame type;
when a transmitting MAC address of the received MAC frame and the MAC address stored in the received frame bitmap information storage unit do not coincide with each other; and
when a TID of the received MAC frame does not coincide with a TID stored in the received frame bitmap information storage unit.

10. The wireless communication apparatus according to claim 4, wherein the TID, which is stored in the TID bitmap storage unit and which belongs to a frame allowing the received frame bitmap information storage unit to store the delivery acknowledgement information, is generated through a negotiation in advance before a frame exchange.

11. A wireless communication apparatus comprising:
a received frame analysis unit which analyzes received MAC frame including MAC Header information;
a plurality of received frame bitmap information storage units each stores delivery acknowledgement information of received MAC frame should be reset on the basis of MAC Header information analyzed by the received frame analysis unit; and
a bitmap reset determination unit which determines whether or not the delivery acknowledgement information of the received MAC frames stored in the plurality of received frame bitmap information storage units on the basis of the MAC Header information of the received MAC frames analyzed by the received frame analysis unit, the plurality of received frame bitmap information storage units being controlled the resets in accordance with the determination result.

12. The wireless communication apparatus according to claim 11, wherein
the bitmap reset determination unit determines that the delivery acknowledgment information stored in the plurality of received frame bitmap information units should not be reset when the received MAC frame analyzed by the received frame analysis unit, the received MAC frame is MAC frame addressed to own apparatus, and is not frame of specified frame type.

13. The wireless communication apparatus according to claim 11, further comprising:
a Block ACK frame generation unit which generates a delivery acknowledgement response frame including delivery acknowledgement information of the received MAC frame stored in any one of the plurality of received frame bitmap information storage units on the basis of a delivery acknowledgement request when a delivery acknowledgement request frame has been analyzed by the received frame analysis unit.

14. The wireless communication apparatus according to claim 11, further comprising:
a traffic ID (TID) bitmap storage unit which stores TIDs of frames allowing the plurality of received frame bitmap information units to store the delivery acknowledgement information, wherein
the bitmap reset determination unit determines whether or not the delivery acknowledgment information of the received MAC frames stored in the plurality of received frame bitmap information storage units should be reset on the basis of the TIDs stored in the TID bitmap storage unit in addition to the MAC Header information of the received MAC frame analyzed by the received frame analysis unit.

15. The wireless communication apparatus according to claim 14, wherein
the plurality of received frame bitmap information storage units further each stores MAC address, being analyzed by the received frame analysis unit, of transmitting wireless communication apparatus corresponding to the delivery acknowledgement information to be stored therein;
the bitmap reset determination unit determines that the delivery acknowledgement information of the received MAC frames stored in the plurality of received frame bitmap information storage units should not be reset
when the received MAC frame analyzed by the received frame analysis unit is frame addressed to own apparatus and the received MAC frame is frame of specified frame type; and
when transmitting MAC address of the received MAC frame and TID of the received MAC frame coincide with any one of the MAC addresses stored in the plurality of received frame bitmap information storage units and any one of TIDs corresponding to the MAC addresses stored in the plurality of received frame bitmap information storage units, respectively.

16. The wireless communication apparatus according to claim 14, wherein
the plurality of received frame bitmap information storage units further each stores MAC address, being analyzed by the received frame analysis unit, of a transmitting wireless communication apparatus corresponding to the delivery acknowledgement information of the received MAC frames to be stored therein;
the bitmap reset determination unit determines that any one piece of the delivery acknowledgement information of the received MAC frames stored in the plurality of received frame bitmap information storage units should be reset when the received MAC frame analyzed by the received frame analysis unit is frame addressed to own apparatus and the received MAC frame is frame of specified frame type;
when transmitting MAC address of the received MAC frame and any one of the MAC addresses stored in the plurality of received frame bitmap information storage units coincide with one another;
when TID of the received MAC frame and any one of TIDs corresponding to the MAC addresses stored in the plurality of received frame bitmap information storage units do not coincide with each another; and
when TID of the received MAC frame coincide with TID stored in the TID bitmap storage unit.

17. The wireless communication apparatus according to claim 14, wherein
the plurality of received frame bitmap information storage units further stores MAC address, being analyzed by the received frame analysis unit, of a transmitting wireless communication apparatus corresponding to the delivery acknowledgement information of the received MAC frames to be stored therein; and
the bitmap reset determination unit determines that any one piece of the delivery acknowledgement information of the received MAC frames stored in the plurality of received frame bitmap information storage units should be reset
when the received MAC frame analyzed by the received frame analysis unit is frame addressed to own apparatus and the received MAC frame is frame of specified frame type;
when transmitting MAC address of the received MAC frame do not coincide with any one of the MAC addresses stored in the plurality of received frame bitmap information storage units;
when TID of the received MAC frame and any one of TIDs corresponding to the MAC address stored in the plurality of received frame bitmap information storage units do not coincide with one another; and
when TID of the received MAC frame do not coincide with TID stored in the TID bitmap information storage unit.

18. The wireless communication apparatus according to claim 14, wherein
the plurality of received frame bitmap information storage units further each stores MAC address, being analyzed by the received frame analysis unit, of a transmitting wireless communication apparatus corresponding to the delivery acknowledgement information of the received MAC frames to be stored therein; and
the bitmap reset determination unit determines that the delivery acknowledgement information of the received MAC frames stored in the plurality of received frame bitmap information storage units should not be reset
when the received MAC frame analyzed by the received frame analysis unit is frame addressed to own apparatus and the received frame is frame of specified frame type;
when transmitting MAC address of the received MAC frame and any one of the MAC addresses stored in the plurality of received frame bitmap information storage units do not coincide with one another; and
when TID of the received MAC frame coincide with TID stored in the TID bitmap storage unit.

19. The wireless communication apparatus according to claim 14, wherein
the plurality of received frame bitmap information storage units further each stores MAC address, being analyzed by the received frame analysis unit, of a transmitting wireless communication apparatus corresponding to the delivery acknowledgement information of the received MAC frames to be stored therein; and
the bitmap reset determination unit determines that the delivery acknowledgement information of the received MAC frames stored in the plurality of received frame bitmap information storage units should not be reset
when the received MAC frame analyzed by the received frame analysis unit is frame addressed to own apparatus and the received MAC frame is frame of specified frame type;
when transmitting MAC address of the received MAC frame and any one of the MAC addresses stored in the plurality of received frame bitmap information storage units do not coincide with one another; and
when TID of the received MAC frame do not coincide with TID stored in the TID bitmap storage unit.

20. A wireless communication apparatus comprising:
receiving a MAC frame including MAC Header information;
analyzing the MAC Header information to store delivery acknowledgement information of a received MAC frame on the basis of the analyzed MAC Header information;
determining whether or not the delivery acknowledgement information of the received MAC frame stored in the storage unit should be reset on the basis of the MAC Header information of the received MAC frame; and
controlling the reset of the delivery acknowledgement information stored in the storage unit on the basis of a result of the determination.
